(19) United States
(12) Patent Application Publication
(10) Pub. No.: US 2026/0205466 A1
(43) Pub. Date: Jul. 16, 2026

(54) MULTI-LEVEL ACCESS TREE FOR COMBINING POLICY CORPUSES

(71) Applicant: Oracle International Corporation, Redwood Shores, CA (US)

(72) Inventors: Thomas James Andrews, Seattle, WA (US); Matthew Wilson Hoover, Maple Valley, WA (US)

(73) Assignee: Oracle International Corporation, Redwood Shores, CA (US)

(21) Appl. No.: 19/427,242

(22) Filed: Dec. 19, 2025

Related U.S. Application Data
(60) Provisional application No. 63/740,729, filed on Dec. 31, 2024.

(51) Int. Cl. H04L 9/40; H04L 67/10

(52) U.S. Cl. CPC H04L 63/105; H04L 63/20; H04L 67/10

(57) ABSTRACT

A policy enforcement system is disclosed that provides a secure framework for accessing resources by evaluating multiple different policy corpuses across different tenancies in a cloud environment. The system obtains a request to perform an action on a resource. The system identifies multiple policies related to a compartment identified for the resource and identifies multiple policies related to a compartment identified for a requestor of the request. The resource resides in a first tenancy and the requestor is associated with a second tenancy in the multi-tenancy cloud computing environment. The system generates an access tree comprising multiple leaf nodes, where the leaf nodes represent the multiple policies. The system evaluates the access tree comprising the multiple policies and provides an evaluation result based on the evaluation.

### CROSS-REFERENCES TO RELATED APPLICATIONS

The present application is a non-provisional application of and claims the benefit and priority under 35 U.S.C. 119(e) of U.S. Provisional Application No. 63/740,729, filed Dec. 31, 2024 entitled “Multi-Level Abstract Syntax Tree For Combining Policy Corpuses,” the entire contents of which are incorporated herein by reference for all purposes.

### BACKGROUND

The rapid expansion of cloud-based services and applications has led to a significant increase in the number of resources that cloud service providers (CSPs) must manage securely. To ensure secure access, CSPs evaluate intricate and dynamic policies, also known as permissions, that dictate how users interact with resources in the cloud. Cloud-based security solutions play a critical role in safeguarding sensitive information by enforcing comprehensive data protection policies tailored to the unique demands of cloud environments. A central component of these solutions is Identity and Access Management (IAM). IAM systems enhance cloud data security by establishing policies that govern how user identities are created, managed, and authenticated, and by regulating each user's access to various resources within the cloud. These policies can be configured to define specific user roles, restricting what actions users may perform and which resources they can access. When a user, a group of users, or an assigned user role attempts to access a cloud resource, the IAM system evaluates the applicable policies to determine whether the requested access should be permitted or denied. In this way, IAM solutions provide a systematic and reliable method for controlling access and protecting data in the cloud.

One common approach for evaluating polices involves the use of Abstract Syntax Trees (ASTs). ASTs provide a structured representation of policies to systematically process and evaluate each component of a policy. By traversing the AST, an IAM system can analyze specific conditions and expressions embedded in a policy to determine whether to grant or deny a particular access request (for example, when a “User” attempts to perform an “Action” on a “Resource”). However, unlike traditional IT environments, where a single, straightforward policy often determines access, cloud environments require a far more complex, multi-step evaluation process. For example, when a user from one tenancy attempts to access a resource located in another tenancy, the IAM system must separately retrieve and evaluate the relevant access policies from both tenancies before making a final decision. This cross-tenancy policy evaluation can be slow and cumbersome, introducing delays and complexity. To address these challenges, there is a need to develop more advanced mechanisms that enable stronger, more secure, and more efficient access control across cloud environments.

### BRIEF SUMMARY

The present disclosure relates to generally to evaluating policies for regulating a user's access to resources in a cloud and more particularly to a policy enforcement system that provides a robust and secure framework for accessing resources by evaluating multiple different policy corpuses across different tenancies in a cloud environment.

In certain embodiments, a policy enforcement system is disclosed. The system obtains a request to perform an action on a resource. The system identifies multiple policies related to a compartment identified for the resource and identifies multiple policies related to a compartment identified for a requestor of the request. The resource resides in a first tenancy and the requestor is associated with a second tenancy in the multi-tenancy cloud computing environment. The system generates an access tree comprising multiple leaf nodes, where a first leaf node represents multiple policies related to a compartment identified for the resource and the second leaf node represents multiple policies related to a compartment identified for a requestor of the request. The system evaluates the access tree comprising the multiple policies and provides an evaluation result based on the evaluation.

In certain examples, the system identifies multiple policies associated with any child compartment related to the resource. The system represents the multiple policies by a third leaf node in the access tree and further determines whether the action on the resource is permitted is further based on evaluating the access tree that identifies multiple policies associated with any child compartment related to the resource.

In certain examples, the system identifies multiple policies associated with any ancestor compartment related to the resource. The system represents the multiple policies by a fourth leaf node in the access tree and further determines whether the action on the resource is permitted is further based on evaluating the access tree that identifies multiple policies associated with any ancestor compartment related to the resource.

In certain examples, the system identifies multiple policies associated with any ancestor compartment related to the requestor. The system represents the multiple policies by a fifth leaf node in the access tree and further determines whether the action on the resource is permitted is further based on evaluating the access tree that identifies multiple policies associated with any ancestor compartment related to the requestor.

In certain examples, the system identifies multiple system policies. The system policies represent policies that apply to any tenancy in a plurality of tenancies in the multi-tenancy cloud computing environment. In certain examples, the system identifies multiple managed system policies. The managed system policies represent policies that apply to any managed compartment in a plurality of tenancies in the multi-tenancy cloud computing environment. In certain examples, the system determines whether the action on the resource is permitted is further based on evaluating the access tree comprising the system policies and the managed system policies. In certain implementations, the system policies is represented by a sixth leaf node in the access tree and the managed system policies is represented by a seventh leaf node in the access tree.

In certain examples, generating the access tree comprises selecting, from the multiple leaf nodes, a subset of leaf nodes to be connected based on access rules, determining a connector node for connecting the selected subset of leaf nodes and connecting the selected subset of leaf nodes using the determined connector to generate a subtree.

In certain examples, generating the access tree comprises generating multiple subtrees. A subtree is generated by selecting, from the multiple leaf nodes, a subset of leaf nodes to be connected using a plurality of access rules, selecting, from the multiple subtrees, a subset of subtrees to be connected using the plurality of access rules, determining a connector node for connecting the subset of subtrees and connecting the selected subset of subtrees using the determined connector to generate the access tree. In certain examples, the connector node for connecting the subset of leaf nodes or the subset of subtrees is an intersection node or a union node.

In certain examples, the access rules (1) a relationship between at least the first tenancy and the second tenancy identified in the access request, (2) a relationship between the first set of policies and the second set of policies or (3) a relationship between the first set of policies, the second set of policies and system policies. The system policies represent policies that are applicable to any tenancy in the plurality of tenancies in the multi-tenant cloud computing environment.

In certain examples, generating the access tree comprises selecting, from multiple leaf nodes, a subset of leaf nodes to be connected based on access rules, determining a deny node for connecting the selected subset of leaf nodes, where the deny node represents a deny policy that is applicable to the request and connecting the selected subset of leaf nodes using the deny node using the access rules.

In certain examples, the system determines the deny node for connecting the selected subset of leaf nodes dynamically during the generation of the access tree. In certain examples, the system dynamically generates the access tree at runtime based on the request to perform the action on the resource. In certain examples, the first tenancy in the multi-tenancy cloud computing environment is different from the second tenancy in the multi-tenancy cloud computing environment.

Various embodiments are described herein, including methods, systems, non-transitory computer-readable storage media storing programs, code, or instructions executable by one or more processors, and the like. These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts a high level diagram of a computing environment 100 comprising a cloud service provider infrastructure (CSPI) that includes capabilities for providing a robust and secure framework for evaluating multiple different policy corpuses across different tenancies in the CSPI, according to certain embodiments.

FIG. 2 depicts an example of a process performed by the policy enforcement system in the CSPI shown in FIG. 1, according to certain embodiments.

FIG. 3 depicts an example of a process performed by the access tree generator in the policy enforcement system in the CSPI shown in FIG. 1 to build a multi-level access tree of policies, according to certain embodiments.

FIG. 4 is an exemplary illustration of a multi-level access tree generated by an access tree generator in the policy enforcement system shown in FIG. 1 in accordance with certain embodiments.

FIG. 5 is an exemplary illustration of a multi-level access tree generated by an access tree generator in the policy enforcement system shown in FIG. 1 that comprises deny nodes, in accordance with certain embodiments.

FIG. 6 depicts an example of a process performed by the policy enforcement system in the CSPI shown in FIG. 1, according to certain embodiments.

FIG. 7 is a block diagram illustrating one pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating an example computer system, according to at least one embodiment

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates to generally to evaluating policies for regulating a user's access to resources in a cloud and more particularly to a policy enforcement system that provides a robust and secure framework for accessing resources by evaluating multiple different policy corpuses across different tenancies in a cloud environment.

As discussed in the Background section, in cloud environments, resources and users are typically governed by separate policies that can be distributed across various tenancies (isolated cloud environments) and even across different cloud systems or services. Granting access to resources in a cloud environment can oftentimes be a complex and time consuming process that can involve evaluating and combining policies from different tenancies and systems in the cloud environment. In certain cases, policy evaluation can even span multiple levels of the cloud environment, i.e., across several compartments and across different tenancies in the cloud environment. For example, when a user requests access to a resource that exists outside their own tenancy (for example, in another department, business unit, or a partner organization using the same cloud provider), all relevant policies that could impact the access request must be identified, not just from the user's own tenancy, but also from the resource's tenancy and from overarching system-wide policies. Existing policy evaluation techniques in cloud environments require each policy in a tenancy's policy corpus to be individually analyzed, with the results from multiple tenancies manually combined to make a final access decision. This process is not only slow and labor-intensive, but also poses challenges for effective, scalable access control in complex cloud environments.

The various embodiments described in the present disclosure address deficiencies of existing policy evaluation techniques. In certain embodiments, a policy enforcement system is disclosed that provides a robust and secure framework for evaluating multiple different policy corpuses across different tenancies in a cloud environment. The policy enforcement system can ensure secure, reliable access to resources by evaluating policies at multiple levels, e.g., across multiple compartments and across multiple tenancies in a cloud environment. The operations performed by the policy enforcement system generally begins with identifying all policies that are relevant to an access request. These policies may include, for instance, system policies that are default, built-in rules provided by the cloud platform that govern basic access and operations in the cloud environment, customer policies that are custom policies created and managed by the organization using cloud services and tailored to meet specific business and security needs of the organization, compartment policies that include policies linked to the specific compartment (e.g., department, project group) where the resource resides, parent compartment policies that include policies associated with higher-level (parent) compartments, and up to the root compartment where the resource resides, tenancy policies that are policies defined at the tenancy level, and so on.

Once all relevant policy sets are identified, the policy enforcement system builds a multi-level access tree to organize and evaluate these policies. In the first stage of processing, the policy enforcement system creates a set of subtrees by connecting leaf nodes of the access tree. Each leaf node in the access tree represents a specific set of multiple policies (for example, all policies for a compartment or tenancy). The system selects the leaf nodes to be connected and determines how these nodes should be connected (e.g., using a connector operator such as a union operator or an intersect operator) based on a set of access rules. The access rules define relationships between policies from different tenancies and compartments, ensuring that hierarchical structures and dependencies are respected. The connected nodes form subtrees in the access tree that represent grouped policy evaluations. In a second stage of processing, the policy enforcement system connects these subtrees according to the access rules to create a single comprehensive multi-level access tree. The completed multi-level access tree comprises all the relevant multiple policy sets and their relationships that are applicable to the access request.

The policy enforcement system then evaluates the multi-level access tree by processing each leaf node and connector and applying the access rules to determine if the combined result grants or denies access. In certain approaches, the evaluation is performed by representing the elements of a policy using an Abstract Syntax Tree (AST). By traversing the AST, the policy enforcement system systematically processes and evaluates each component of the policy and evaluates specific conditions and expressions embedded in the policy to determine whether to grant or deny a particular access request (for example, when a “User” attempts to perform an “Action” on a “Resource”). This comprehensive, multi-layered evaluation ensures that all relevant security requirements are met, providing robust and flexible access control in complex cloud environments.

Using the multi-layered access tree framework described above, users of organizations can satisfy their complex security needs while maintaining flexibility and control over their cloud resource permissions. The disclosed multi-layered access tree framework can be utilized in various different scenarios in a cloud environment. For example, a user might request access to a sensitive resource located in a child compartment of a different tenancy in the cloud environment. The policy enforcement system described herein gathers different sets of policies that are applicable to the access request. For instance, the different sets of multiple policies for this request may include, for instance (1) policies for the child compartment (2) policies for all parent compartments (up to the root compartment) of the child compartment (3) system policies (4) customer policies and (5) policies from the target tenancy from which the user's request was made and so on. The policy enforcement system then organizes the multiple policies into an access tree, with each leaf node in the access tree representing a set of multiple policies and the connectors in the tree defining how the multiple sets of policies interact. The system evaluates the tree, applying access rules that account for the hierarchy and relationships between compartments and tenancies. Based on the evaluation, the system grants or denies access, ensuring that all security requirements are satisfied.

In certain embodiments, the policy enforcement system supports the creation of explicit deny policies through the use of one or more deny nodes (sometimes referred to herein as “inversion nodes”). Deny policies may be used to explicitly specify actions a user or principal is prohibited from performing on resources in the cloud environment. The deny nodes may be identified by the policy enforcement system and these deny nodes may be added to the access tree at run time during the creation of the access tree. For instance, a deny node can be added to the access tree to safely delegate a subset of permissions to a compartment without needing to predefine every action. Deny policies can also be used by the policy enforcement system to easily control tenancy-wide restrictions with a single statement (rather than requiring modifications to all other policies).

The new and improved architecture of the multi-level access tree for evaluating policies provides a secure framework for managing access to cloud resources within a cloud environment across multiple tenancies and compartments in the cloud. The multi-level access tree can be tailored to the specific access request being processed and can be dynamically constructed by the policy enforcement system at runtime. The evaluation of policies using the multi-level access tree can be further optimized by the policy enforcement system to enhance efficiency and reduce unnecessary computation of individual policies. These optimizations can be applied by the policy enforcement system at run time during evaluation of the multi-level access tree. For instance, while evaluating a union node (i.e., a type of connector node that represents a logical OR condition) in the access tree, the policy enforcement system can immediately grant the requested permission as soon as any child node in the tree provides that permission. The remaining child nodes need not be evaluated once access is granted. If the union node is composed only of empty children, it can itself be pruned from the tree, since there are no permissions to grant. For intersection nodes (i.e., another type of connector node that represents a logical AND condition), policy evaluation can cease as soon as any child node fails to grant the requested permission. Additionally, if an intersection node has one or more empty children (representing no possible permissions), that branch can be pruned, as it cannot contribute to granting access.

In certain implementations, the policy enforcement system described herein also includes capabilities to prune parts of the multi-level access tree that are irrelevant to the current request as the tree is being constructed. For instance, branches related to certain compartments in the tree can be excluded if the request does not target the compartment. Additionally, the use of deny nodes in the access tree can additionally allow the policy enforcement system to eliminate entire sections of the tree, further streamlining access checks. By applying optimizations during policy evaluation and strategically pruning the access tree at runtime, the policy enforcement system described herein achieves both robust access control and high operational efficiency. This ensures that only relevant policies are processed for each request, reducing workload and improving response times for complex access management scenarios in cloud environments.

### System Overview

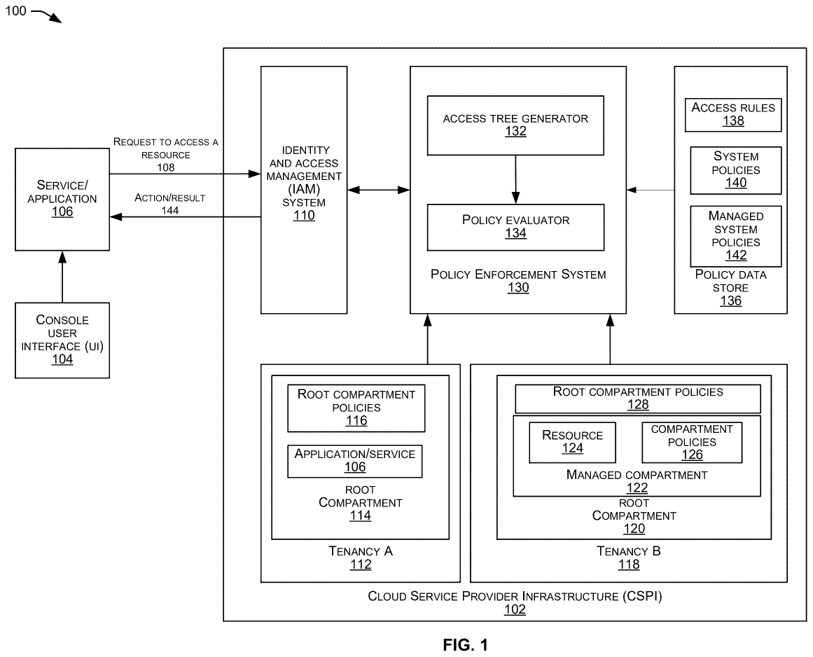

Referring now to the drawings, FIG. 1 depicts a high level diagram of a computing environment 100 comprising a cloud service provider infrastructure (CSPI) that includes capabilities for providing a robust and secure framework for evaluating multiple different policy corpuses across different tenancies in the CSPI, according to certain embodiments. In certain examples, the secure framework for policy evaluation is provided by a policy enforcement system 130 within the CSPI 102. The policy enforcement system 130 may be implemented by one or more computing systems that execute computer-readable instructions (e.g., code, program) to implement the policy enforcement system 130. In the embodiment depicted in FIG. 1, the policy enforcement system 130 includes various subsystems including an access tree generator 132 and a policy evaluator 134. Portions of data or information used by or generated by the policy enforcement system 130 as part of its processing may be stored in a persistent memory such as a policy data store 136. The CSPI 102 additionally includes an identity and access management (IAM) system 110 for verifying the user's identity to access certain resources in the cloud. The systems and subsystems depicted in FIG. 1 may be implemented using only software (e.g., code, instructions, program) executed by one or more processing units (e.g., processors, cores) of a computing system, hardware, or combinations thereof. The software may be stored on a non-transitory storage medium (e.g., on a memory device).

The policy enforcement system 130 may be implemented in various different configurations. In the embodiment depicted in FIG. 1, the policy enforcement system 130 is implemented on one or more servers in the CSPI and its secure resource access and policy evaluation services may be provided to subscribers of cloud services on a subscription basis. Computing environment 100 depicted in FIG. 1 is merely an example and is not intended to unduly limit the scope of claimed embodiments. One of ordinary skill in the art would recognize many possible variations, alternatives, and modifications. For example, in some implementations, the policy enforcement system 130 can be implemented using more or fewer subsystems than those shown in FIG. 1, may combine two or more subsystems, or may have a different configuration or arrangement of subsystems.

According to certain examples described herein, the policy enforcement system 130 is capable of providing secure, reliable, and scalable access to cloud resources by evaluating multiple policy corpuses. i.e., collections of policies across different tenancies in a multi-tenancy cloud computing environment (e.g., the CSPI 102). When a user requests access to a resource, the policy enforcement system 130 identifies and combines policies from different tenancies and compartments that are applicable to the request (e.g., the user's tenancy, the target resource's tenancy and all relevant compartments and their policies within those tenancies) to determine if access to the resource can be granted. Each tenancy may represent a secure and isolated partition for managing cloud resources provided by the CSPI 102. Each tenancy may function as a standalone environment for a specific organization, department, or customer of the CSPI 102. For example, there may be separate tenancies such as Tenancy A 112 and Tenancy B 118 as shown in FIG. 1. Although the embodiment depicted in FIG. 1 shows two tenancies, in alternate embodiments, the CSPI 102 may comprise additional tenancies. A tenancy (e.g., tenancy A 112 or tenancy B 118) may comprise a set of users (individual accounts), user groups, policies that govern access to resources in the tenancy. In addition, each tenancy may be associated with a root compartment which is the top-level container for all resources and sub-compartments in that tenancy. As described herein, a compartment may refer to a logical container within a tenancy used to organize resources and control access at a granular level. Each compartment can have its own set of policies, which define who can access or use the resources within that compartment. These policies can restrict actions on resources such as compute resources (virtual machines, processing units), networking resources (virtual networks, firewalls), object storage resources (buckets, files), databases and so on in the CSPI. For instance, as illustrated in FIG. 1, tenancy A 112 may be associated with a root compartment 114 and an associated set of policies 116. Similarly, tenancy B 118 may associated with its own root compartment 120 and an associated set of policies 128.

In certain examples, the policy enforcement system 130 described herein is capable of handling requests from users who belong to a specific customer or tenancy within the CSPI. A user can submit their access request 108 through various methods, such as a graphical user interface (e.g., a console UI 104) provided by a cloud service, an Application Programming Interface (API), which allows for automated or programmatic requests or via a command line interface (CLI) on the user's computing device. The computing device may be of various types, including but not limited to, a mobile phone, a tablet, a desktop computer, and the like. When the user submits a request (for example, to read data from a database or start a virtual machine), an Identity and Access Management (IAM) system 110 within the CSPI 102 intercepts the request and then identifies the user making the request. This includes determining the user's identity, their associated groups, and their tenancy. The IAM system 110 forwards this information, along with the details of the requested operation and the target resource, to the policy enforcement system 130 for further processing.

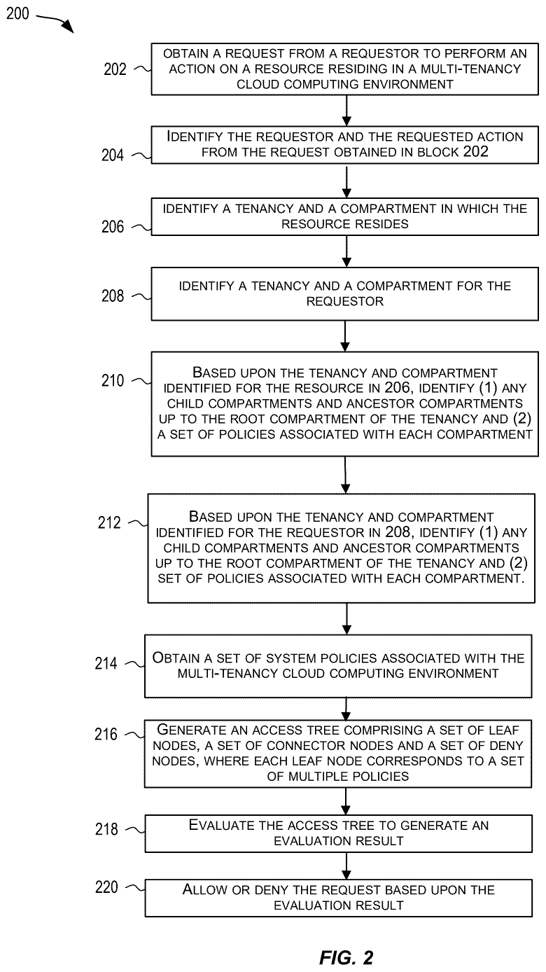

The policy enforcement system 130 uses the information provided by the IAM system 110 to determine whether the user has the necessary permissions to access the resource based on evaluating all applicable policies across the relevant tenancies and compartments in the CSPI. The policy enforcement system 130 system gathers all applicable policies: those for the child compartment, its parent compartments, the organization's custom policies, the default system policies, and any tenancy-wide policies and organizes those policies into an access tree. The policy enforcement system 130 additionally adds logical connectors reflecting how the sets of multiple policies can interact based on access rules (e.g., an access rule may specify that the operation can be allowed if all relevant policies permit the action). The system 130 then evaluates the tree, checking if any policy denies the action or if all required policies allow it. Based on the processing performed by the system, the system generates a result 144. The result 144 is presented to the user, typically through the user interface (UI) on their device, providing clear feedback on whether the requested operation was allowed or blocked. By evaluating policies across multiple tenancies and compartments, and organizing resources according to logical criteria, the policy enforcement system 130 described herein provides a comprehensive and secure framework for managing access to cloud resources within a CSPI. Additional details related to the processing performed by the IAM system 110 and the various subsystems (e.g., 132 and 134) of the policy enforcement system 130 are described in FIG. 2.

### Example Process

FIG. 2 depicts an example of a process 200 performed by the policy enforcement system in the CSPI shown in FIG. 1, according to certain embodiments. The processing depicted in FIG. 2 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 200 presented in FIG. 2 and described below is intended to be illustrative and non-limiting. Although FIG. 2 depicts the various processing steps occurring in a particular sequence or order, this is not intended to be limiting. In certain alternative embodiments, the steps may be performed in some different order or some steps may also be performed in parallel. In certain embodiments, the processing described in FIG. 2 may be performed by the IAM system 110 and the various subsystems (e.g., 132 and 134) of the policy enforcement system 130.

The processing depicted in FIG. 2 is initiated at block 202 when the policy enforcement system 130 obtains a request 108 from a requestor to perform an action on a resource residing in a multi-tenancy cloud computing environment (e.g., the CSPI 102). The requestor (i.e., the entity seeking access) could be an individual user (such as a customer of the CSPI who subscribes to the services provided by the CSPI) who can make the request through several interfaces such as a console UI, an API or a via CLI in the user's device. In certain cases, the requestor can also be an application or a service, rather than a human user, who can submit the request 108 to the policy enforcement system 130 on behalf of the user. For example, the request 108 can be submitted by a “service principal”—a unique identity assigned to an application or service (e.g., 106) within the cloud environment to perform a specific action (such as reading, writing, or deleting data) on a resource within the cloud environment. For instance, a database service 106 (as a service principal) in tenancy A 112 may need to access an object storage bucket managed by a customer in a specific compartment in tenancy B 118.

When an access request 108 is submitted, the IAM system 110 in the CSPI 102 intercepts the request 108 and identifies the requestor by verifying the user's identity or the service principal of the application/service (e.g., 106) making the request. The IAM system 110 then gathers relevant authentication and authorization details and forwards this information along with details about the requested action and target resource to the policy enforcement system 130 for further analysis.

At block 204, the policy enforcement system 130 identifies the requestor and the requested action from the request received in block 202. As part of the processing performed in block 204, the policy enforcement system 130 first identifies the “service principal” associated with the access request. As previously described, the service principal is a unique identity assigned to an application, service, or an automated process in the cloud environment. The policy enforcement system 130 then extracts details of the requested action—such as “read data from an object storage bucket”—from the request to identify the operation the requester intends to perform on the resource.

At block 206, the policy enforcement system 130 identifies a tenancy and a compartment in which the resource resides. This step involves identifying the tenancy that owns the resource and the compartment (the logical container or subgroup) within the tenancy where the resource resides. For instance, as a result of the processing performed in block 206, the policy enforcement system 130 may determine that the resource (e.g., 124) being accessed is an object storage bucket that is located in a “managed compartment” 122 within a tenancy (e.g., “Tenancy B” 118) of the CSPI 108.

At block 208, the policy enforcement system 130 identifies the requester's tenancy and compartment. For instance, the policy enforcement system 130 may determine that the requester (i.e., a service principal for a database service 106) is located in the “root compartment” 114 of a tenancy (e.g., “Tenancy A” 112) within the CSPI 102. By systematically identifying the service principal (requester), extracting the details of the requested action, and determining the exact locations (tenancies and compartments) of both the requester and the resource, the policy enforcement system 130 ensures that it has all necessary context to accurately evaluate applicable policies and make a secure access decision.

At block 210, after determining the tenancy and specific compartment where the resource resides in block 206, the policy enforcement system 130 identifies all (i.e., a set of zero or more) ancestor compartments related to the resource. Ancestor compartments comprise all the compartments that exist between the resource's immediate compartment and the root compartment at the top of the tenancy's hierarchy. For instance, in the embodiment depicted in FIG. 1, the resource 124 resides in a managed compartment 122 and the ancestor compartment for the resource is the root compartment 120 at the top of the tenancy's hierarchy. For each compartment identified (from the resource's own compartment up through its ancestors to the root), the policy enforcement system 130 collects all the policies (e.g., compartment policies 126 and root compartment policies 128) that are associated with that compartment. Compartment policies are directly associated with specific compartments (logical containers such as departments, projects, or business units) within a tenancy. Compartment policies determine who can access or manage the resources inside that compartment and may be unique to each compartment's purpose or sensitivity. In certain examples, the compartment policies that may be identified may include, for example:
(1) Root Compartment Policies (e.g., 128) which comprise policies attached to the root compartment (e.g., 120), which generally apply to all compartments and resources within the tenancy (e.g., tenancy B 118). These policies may serve as the overarching rules that govern access across the entire tenancy;
(2) Managed Compartment Policies (e.g., 126) which comprise policies are specific to the compartment (e.g., 122) where the resource (e.g., 124) is located, which may define more granular or restrictive rules for accessing resources within that compartment; and
(3) Child Compartment Policies (if any)-If the resource's compartment contains any child compartments (sub-compartments), the policy enforcement system 130 may also collect policies associated with these compartments.

At block 212, once the tenancy and specific compartment where the requestor resides have been determined in block 208, the policy enforcement system 130 identifies the requestor's immediate compartment, as well as all ancestor compartments, up to and including the root compartment of the tenancy. For every compartment identified in the requestor's hierarchy (from the immediate compartment up to the root), the policy enforcement system 130 collects all policies associated with each compartment. These policies may include, but are not limited to:
(1) Root Compartment Policies (e.g., 116) which are policies attached to the root compartment (e.g., 114), which typically apply across the entire tenancy (e.g., tenancy A 112) and to any entities within it.
(2) Intermediate and Immediate Compartment Policies which are policies specific to each parent compartment and the compartment where the requestor is located.

In certain embodiments, in addition to the policies identified in blocks 210 and 212 as described above, the policy enforcement system 130 collects a comprehensive set of policies that apply at various levels-globally, across tenancies, and within specific compartments across tenancies. This ensures that every relevant policy (rule), whether broad or highly specific, is considered during policy evaluation. Accordingly, at block 214, the policy enforcement system 130 obtains a set of policies that may include:
(1) System Policies 140 which are default, built-in rules provided by the cloud platform. These policies are applicable to any tenancy, user, and resource within the cloud environment, ensuring consistent enforcement of essential access controls and operations; and
(2) Managed system policies 142 which are specialized system policies that apply to particular types of compartments (such as “managed” compartments) throughout any tenancy in the cloud environment 102. Managed system policies may, for example, impose stricter controls or additional requirements on sensitive compartments (also referred to herein as “managed compartments”) that are centrally managed in the cloud environment.

In certain embodiments, in addition to the system policies 140 and the managed system policies 142, the policy enforcement system 130 may also gather customer policies (not shown in FIG. 1) which are custom policies defined and maintained by individual organizations (customers) using the cloud services. Customer policies are tailored to reflect the unique business rules, security requirements, and compliance needs of each organization. In certain implementations, the system policies 140, the managed system policies 142 and the customer policies may be stored in a policy data store 136 that is accessible to the policy enforcement system 130 for analysis.

By systematically identifying the resource's compartment, tracing its hierarchy up to the root compartment, and collecting applicable policies at each level, the policy enforcement system 130 described herein ensures that every relevant policy is considered in the access decision. By methodically identifying compartments in the requestor's hierarchy and collecting every policy associated with these compartments, the policy enforcement system 130 ensures that relevant organizational rules are considered. Additionally by gathering and evaluating global system policies and managed system policies, customer-specific rules, and compartment-level policies, the policy enforcement system 130 ensures that relevant security and operational requirements are addressed. This comprehensive, multi-layered policy collection enables robust, consistent, and flexible access control across a complex, multi-tenancy cloud environment.

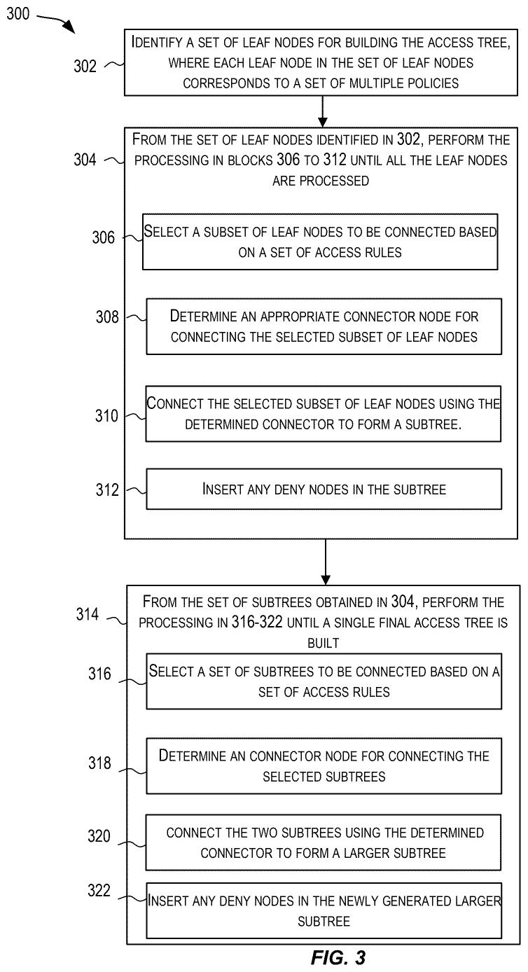

At block 216, once the relevant policies that are applicable for evaluating the access request have been gathered, the policy enforcement system 130 builds an access tree comprising a set of leaf nodes and a set of connector nodes. In certain implementations, the access tree is built by an access tree generator 132 in the policy enforcement system 130. Each leaf node in the set of leaf nodes may represent a set of multiple policies. Additional details related to the processing performed by the access tree generator 132 to build an access tree is described in FIG. 3.

At block 218, the access tree is evaluated to generate an evaluation result. In certain embodiments, the evaluation of the access tree is performed by the policy evaluator 134 in the policy enforcement system 130. In certain approaches, the evaluation is performed by representing the elements of a policy using an Abstract Syntax Tree (AST). By traversing the AST, the policy evaluator 134 systematically processes and evaluates each component of the policy and evaluates specific conditions and expressions embedded in the policy to determine whether to grant or deny a particular access request (for example, when a “User” attempts to perform an “Action” on a “Resource”).

At block 220, the policy evaluator 134 allows or denies the request based upon the evaluation result. The result (e.g., 144) is presented to the user, typically through the user interface (UI) on their device, providing clear feedback on whether the requested operation was allowed or blocked. By evaluating policies across multiple tenancies and compartments, and organizing resources according to logical criteria, the policy enforcement system 130 described herein provides a comprehensive and secure framework for managing access to cloud resources within a CSPI.

### Access Tree Generation

FIG. 3 depicts an example of a process 300 performed by the access tree generator in the policy enforcement system in the CSPI shown in FIG. 1 to build a multi-level access tree of policies, according to certain embodiments. The processing depicted in FIG. 3 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 300 presented in FIG. 3 and described below is intended to be illustrative and non-limiting. Although FIG. 3 depicts the various processing steps occurring in a particular sequence or order, this is not intended to be limiting. In certain alternative embodiments, the steps may be performed in some different order or some steps may also be performed in parallel.

The processing performed by the access tree generator 132 to build a multi-level access tree of policies comprises multiple stages. In a first stage of processing, and as described in blocks 302 and 304 below, a set of subtrees associated with the access tree are built. As part of the processing performed to build a set of subtrees, at block 302, the access tree generator 132 first identifies a set of leaf nodes for building the access tree. Each leaf node in the set of leaf nodes corresponds to a set of multiple policies that are associated with a tenancy, a set of multiple polices associated with a compartment or a comprehensive set of policies that apply at various levels—globally, across tenancies, and within specific compartments across tenancies. For instance, a set of multiple policies represented by a leaf node in the access tree may represent:
(1) Policies associated with a root compartment of a tenancy in which the resource resides—e.g., obtained as a result of the processing performed in block 210 in FIG. 2;
(2) Policies associated with a child compartment in the root compartment in which the resource resides—e.g., obtained as a result of the processing performed in block 210 in FIG. 2;
(3) Policies associated with a root compartment of a tenancy in which the requestor resides—e.g., obtained as a result of the processing performed in block 212 in FIG. 2;
(4) System Policies that can apply to any of the tenancies in the multi-tenancy cloud computing environment, e.g., obtained as a result of the processing performed in block 214 in FIG. 2; or
(5) Policies that can apply to certain types of compartments (e.g., “managed” compartments) across any of the tenancies in the multi-tenancy cloud computing environment, e.g., obtained as a result of the processing performed in block 214 in FIG. 2.

At block 304, from the set of leaf nodes identified in block 302, the access tree generator 132 generates a set of one or more subtrees. In particular, to generate the set of subtrees, the access tree generator 134 performs the processing described in blocks 306-312 until all the leaf nodes are processed. At block 306, the access tree generator 132 selects a subset of leaf nodes to be connected based on a set of access rules (e.g., access rules 138 stored in the policy data store 136). The access rules 138 can be used by the access tree generator 132 to select a subset of leaf nodes for processing using a variety of criteria such as (1) a relationship between the tenancies identified in the access request (2) a relationship between the sets of multiple policies defined by the tenancies and the multiple sets of policies associated with each compartment defined in the tenancies and (3) a relationship between the sets of multiple policies defined by the tenancies and a global set of policies (e.g., system policies and managed system policies) that can be applied to any of the tenancies in the multi-tenancy cloud computing environment.

At block 308, the access tree generator determines an appropriate connector node (e.g., a union connector (i.e., a logical OR operator) or an intersection connector (i.e., a logical AND operator) for connecting the subset of leaf nodes based on the access rules.

At block 310, the access tree generator connects the selected subset of leaf nodes using the determined connector to form a subtree.

At block 312, the access tree generator inserts any deny nodes (if identified) into the subtree. In certain examples, a deny node may represent a deny policy implemented by the policy enforcement system to block specific actions while permitting others. Deny policies enable safe delegation of a limited set of permissions to a compartment administrator without the need to explicitly enumerate every permitted action. Details related to the implementation of “deny nodes” and “deny policies” in an access tree are described in the section titled “Implementation of Deny Nodes” below.

In a second stage of processing, once the set of subtrees have been obtained as a result of the processing performed in block 304, the access tree generator 132 generates a single multi-level access tree from the set of subtrees. To generate a single multi-level access tree, the access tree generator performs the processing described in blocks 316-322 until all the subtrees are processed. For example, at block 316, the access tree generator 132 selects a set of subtrees to be connected based on the set of access rules. At block 318, the access tree generator 132 determines a connector node for connecting the selected subtrees. At block 320, the access tree generator 132 connects the subtrees using the determined connector to form a larger subtree. At block 322, the access tree generator optionally inserts any deny nodes in the newly generated larger subtree. Details related to the implementation of “deny nodes” and “deny policies” in an access tree are described in the section titled “Implementation of Deny Nodes” below. The access tree generator 132 repeats the processing described in blocks 316-322 until all the subtrees have been processed and a single multi-level access tree has been built.

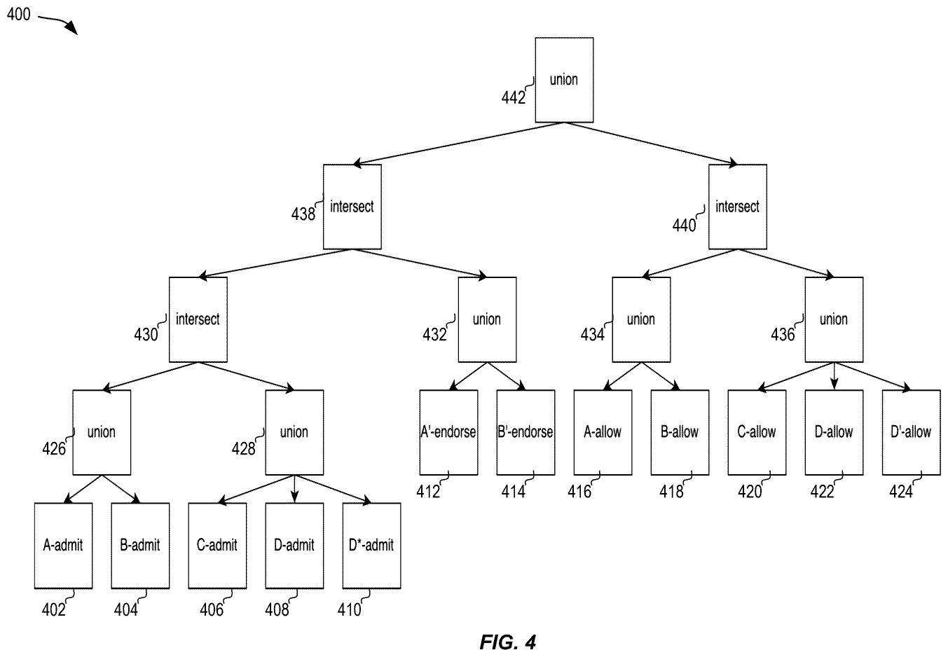

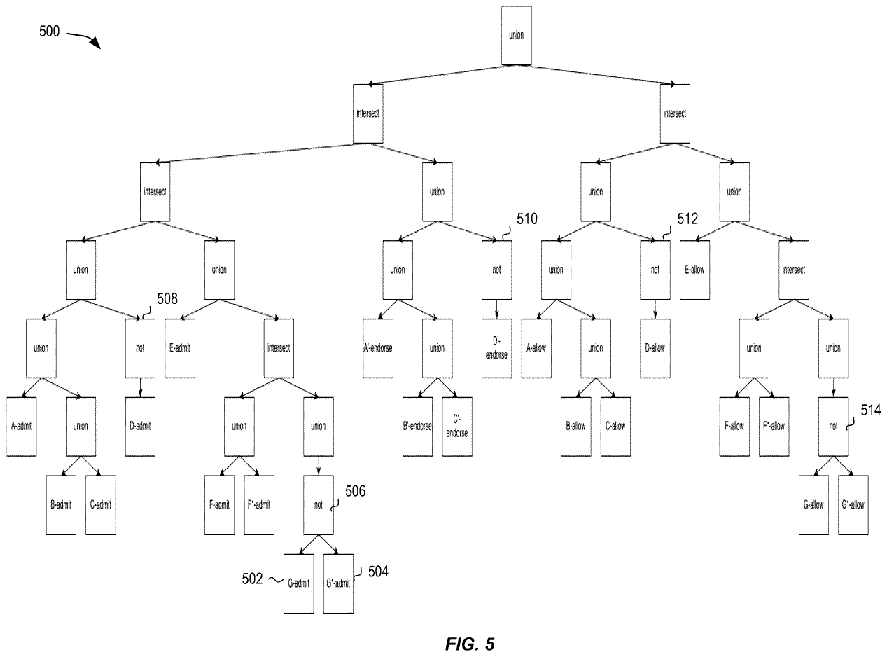

The processing performed by the access tree generator 132 in FIG. 3 can be better understood using examples of access trees generated by the access tree generator 132 described in FIG. 4 and FIG. 5 below.

FIG. 4 is an exemplary illustration of a multi-level access tree generated by an access tree generator in the policy enforcement system shown in FIG. 1 in accordance with certain embodiments. The access tree 400 may be built by the access tree generator in multiple stages. As previously described in FIG. 3, in a first stage of processing, the access tree generator 132 identifies a set of leaf nodes for building the access tree and then builds a set of subtrees using the identified leaf nodes. The set of leaf nodes are identified based on identifying multiple sets of polices to be used for evaluating an access request from a requestor to perform an action on a resource residing in a multi-tenancy cloud computing environment. For example, the multiple sets of policies may be identified based on the identity of the requestor making the request, a tenancy and a compartment of the requestor, a tenancy and a compartment in which the resource reside, over-arching system policies so on. For example, an access request may identify an application or a service (e.g., a database service 106) residing in a tenancy A 112 that needs to access a resource (e.g., an object storage bucket 124) residing in a specific compartment (managed compartment 122) in a different tenancy B 118. For this example, the policies represented by the leaf nodes (e.g., 402, 404, 406, 408, 410, 412, 414, 416, 418, 420, 422 and 422) identified in the access tree 400 that are applicable to the specific access request may include, for example:
(1) Policies associated with a root compartment (represented by the letter B in the access tree shown in FIG. 4) of a tenancy in which the resource resides;
(2) Policies associated with one or more child compartments (represented by the letters D and D* in the access tree shown in FIG. 4) in the root compartment in which the resource resides;
(3) System Policies (represented by the letter A in the access tree shown in FIG. 4) that can apply to any of the tenancies (including the requestor's tenancy and root compartment, represented by A′ in FIG. 4) in the multi-tenancy cloud computing environment; and
(4) Managed System Policies (represented by the letter C in the access tree shown in FIG. 4) that can apply to certain types of compartments (e.g., “managed” compartments) across any of the tenancies in the multi-tenancy cloud computing environment.

In some implementations, the policies represented by the leaf nodes in access tree 400 can be classified as “admit policies,” “endorse policies,” or “allow policies,” each tailored to the specific request being processed. An allow policy generally grants permissions to a group operating within a single tenancy. An endorse policy is typically located in a source tenancy and specifies the actions that a group is authorized to perform in a different, external tenancy. Correspondingly, an admit policy is established in the destination tenancy and provides access to a group from another tenancy, contingent upon a valid endorsement from the source tenancy.

After identifying the leaf nodes and their corresponding policies, the access tree generator builds a set of subtrees. A subtree is built by selecting a subset of leaf nodes to be connected based on a set of access rules. An appropriate connector node (e.g., union- OR/intersection-AND) is then determined for connecting the subset of leaf nodes based on the access rules and the selected subset of leaf nodes are connected using the determined connector to form a subtree. For instance, in the example shown in FIG. 4, a leaf node 402 (representing “admit” system policies) and leaf node 404 (representing “admit” root policies associated with the root compartment in which the resource resides) are connected using a first union operator 426 to form a first subtree. For instance, the “admit” system policies and the “admit root policies” may be determined to be connected using the union operator 426 based on access rules. The access rules may specify that all applicable policy statements (those attached to the root and all parent compartments up to the resource's location) should be combined with overarching system policies to make an access determination. Similarly, leaf nodes 406, 408 and 410 (representing “admit” policies associated with the child compartments of the root compartment in which the resource resides) are connected using a second union operator 428 to form a second subtree based on access rules. The first subtree and the second subtree are then connected using an intersect operator 430 to form a larger subtree based on the set of access rules. The union (logical OR condition) operator ensures the final decision is “allowed” if any of the policy rules defined by the first leaf node and the second leaf node match. The intersect operator acts as an “all of” or logical AND condition. The final policy decision is “allowed” only if every one of the policy rules or sub-policies defined by its child nodes (e.g., a first leaf node and second leaf node, and so on) evaluates to “allowed”. In other words, the “union” operator requires only one condition to be true whereas the intersect operator imposes a stricter requirement, ensuring that the final outcome meets all the specified criteria.

In a similar manner, leaf nodes 412 and 414 (representing system “endorse” policies applicable to the requestor's tenancy and “endorse” policies applicable to the root compartment in which the resource resides) are connected using a third union operator 432 to form a third subtree, leaf nodes 416 and 418 (representing “allow” policies applicable to system policies and root compartment policies associated with the resource) are connected using a fourth union operator 434 to form a fourth subtree and leaf nodes 420, 422 and 424 (representing “allow” policies applicable to the child compartments of the root compartment in which the resource resides) are connected using a fifth union operator 436 to form a fifth subtree. In the second stage, the set of subtrees are combined to form larger subtrees and finally a single access tree using the set of access rules.

In the example illustrated in FIG. 4, access tree 400 comprises larger subtree-1 that may be represented by policy expression-1 shown below and larger subtree-2 that may be represented by policy expression-2 shown below:
Policy Expression 1: (A-admit OR B-admit) AND (C-admit OR D-admit OR D*-admit) AND (A′-endorse OR B′-endorse). This expression requires both an “admit” condition (from A or B) and an “admit” condition (from C, D, or D*) and an “endorse” condition (from A′ or B′) to be true.
Policy Expression 2: (A-allow OR B-allow) AND (C-allow OR D-allow OR D*-allow). This expression requires both an “allow” condition (from A or B) and an “allow” condition (from C, D, or D*) to be true.

The final single multi-level access tree is then generated by combining policy expression-1 represented by larger subtree-1 and policy expression-2 represented by larger subtree-2 to generate a final policy expression. In this case, the final policy expression evaluates to true if policy expression-1 OR policy expression-2 is true.

### Implementation of Deny Policies in a Multi-Level Access Tree

Most access control policies are fundamentally designed to grant (“allow”) access to resources. If a policy does not explicitly allow a particular action, access to that action is automatically denied by default and this is known as the “implicit deny” principle. Deny policies serve a different, but critical, security function. They explicitly prohibit a user or group from accessing certain resources or performing specific actions. Even if other policies would otherwise allow access, a deny policy takes precedence and will override any such permissions, ensuring that the prohibited action cannot be performed. Deny policies can be tailored to prevent access to specific actions (for example, certain management operations) or to broader categories of permissions (such as all “read” or “inspect” actions). By using deny policies, organizations can safely delegate a limited set of permissions to compartment administrators, without needing to exhaustively specify every allowed action. This streamlines permission management and reduces administrative overhead. Deny policies can enforce organization-wide or tenancy-wide restrictions with a single, centralized policy statement. This approach eliminates the need to update or modify each individual allow policy whenever a new restriction must be imposed.

In certain cases, deny policies may be used to explicitly specify actions a user or principal is prohibited from performing, as opposed to “allow” statements, which define permitted actions. For instance, delegating policy-writing authority for a child compartment can be problematic in certain situations. If a user is given permission to write policies in a child compartment, they can potentially grant themselves unrestricted access, circumventing any higher-level controls imposed by the tenancy administrator. The only way to prevent this is for the tenancy administrator to withhold policy-writing privileges from the child compartment entirely and manage all policies centrally. This can be a cumbersome and impractical process for large organizations. Deny policies provide a solution to this challenge by allowing tenancy administrators to enforce critical security restrictions at the root level that cascade down to all child compartments. By establishing “deny” policies at the tenancy root compartment, administrators can ensure that certain actions are always prohibited, regardless of any “allow” policies written in lower-level compartments. This framework enables compartment owners to manage their own “allow” policies as needed, but always within the non-negotiable boundaries set by the overarching “deny” policies. As a result, organizations achieve both robust security and scalable, delegated administration. The use of “Deny” statements can additionally enable administrators specify actions that are categorically forbidden, regardless of subsequent “allow” policies. Root-level deny policies can ensure that no child compartment can override critical security restrictions. Compartment owners gain the flexibility to manage permissions within defined limits, supporting scalable and efficient administration using deny policies.

The following examples illustrate how deny policies can be implemented. A deny policy can be written to block specific actions while still permitting others.

For example: a deny policy such as “deny group foobar to manage buckets in tenancy” prevents the group “foobar” from managing (such as deleting or configuring) any storage buckets within the tenancy. However, it does not stop “foobar” from reading or viewing those buckets—provided there is a separate policy that explicitly allows such access. Because access is “denied by default” unless explicitly permitted (the implicit deny principle), any actions not specifically allowed remain inaccessible. A deny policy can also be used to impose comprehensive restrictions. For instance: a deny policy: “deny group foobar to inspect buckets in tenancy” prohibits “foobar” from performing any actions associated with “inspecting” buckets, including reading their contents or viewing metadata. In this context, “deny inspect” extends to all permissions related to inspecting buckets, effectively blocking every possible action that falls under this category.

In certain situations, a customer may need to address highly specific requirements. Deny policies can target precise permission strings, just as allow policies can grant them.

For example a deny policy: “deny group foobar to {BUCKET_INSPECT} in tenancy” explicitly denies the “BUCKET_INSPECT” permission to the group “foobar.” As a result, “foobar” is blocked from performing any action that requires the “BUCKET_INSPECT” permission, regardless of other policies that may exist. Thus, deny polices ensure that certain users or groups are blocked from performing specified operations, regardless of other policies, and are essential for robust, fine-grained access control.

In some implementations, the policy enforcement system 130 described herein enables the creation of explicit deny policies by incorporating one or more deny nodes (also referred to as “inversion nodes”) into the access tree. These deny nodes are dynamically identified and added during the construction of the access tree at runtime. The access tree generator begins by identifying a set of leaf nodes, which serve as the foundational elements for building the access tree. As previously described, the leaf nodes are chosen based on various sets of policies relevant to the access request, such as the identity of the requestor, the tenancy and compartment of the requestor, the tenancy and compartment where the target resource resides and applicable system policies.

Using the identified leaf nodes, the access tree generator constructs subtrees. During this process, the access tree generator also identifies any applicable deny policies and incorporates them into the access tree as deny nodes. For instance, the access tree generator may determine that a group of leaf nodes should be connected through a deny node, which represents a specific deny policy. Deny nodes are inserted into the access tree according to established access rules. The access rules determine both the structure of the access tree and the precedence of deny nodes, ensuring that deny policies can effectively override conflicting permissions, except where superseded by system-level controls. For instance, in certain implementations, the access rules may specify that any policies inserted as deny nodes will override any permissions granted by Allow, Admit, or Endorse policies, regardless of where those policies originate within the compartment hierarchy. The access rules may further specify that overarching system policies may supersede permissions granted by deny policies. In certain cases, the access rules may also incorporate the addition of specific system policies that are designed to be “deniable” to the access tree as nodes in the tree, allowing for fine-grained control and flexibility in policy evaluation.

FIG. 5 is an exemplary illustration of a multi-level access tree generated by an access tree generator in the policy enforcement system shown in FIG. 1 that comprises deny nodes, in accordance with certain embodiments. In the example of the multi-level access tree shown in FIG. 5, the policies represented by the leaf nodes may include:
(1) System Policies (represented by the letter A in the access tree shown in FIG. 5) that can apply to any of the tenancies in the multi-tenancy cloud computing environment;
(2) System Deniable Policies (represented by the letter B in the access tree shown in FIG. 5) that include deny policies that can apply to any of the tenancies in the multi-tenancy cloud computing environment.
(3) Policies associated with a root compartment (represented by the letter C in the access tree shown in FIG. 5) of a tenancy in which the resource resides;
(4) Customer Deniable Policies (represented by the letter D in the access tree shown in FIG. 5) that include deny policies that apply to the customer of the CSPI who is making the request.
(5) Managed System Policies (represented by the letter E in the access tree shown in FIG. 5) that can apply to certain types of compartments (e.g., “managed” compartments) across any of the tenancies in the multi-tenancy cloud computing environment.
(6) Managed customer policies (represented by the letter F in the access tree shown in FIG. 5) that can apply to certain types of compartments (e.g., “managed” compartments) in the customer's tenancy.
(7) Managed customer policies associated with one or more child compartments (represented by the letters F and F* in the access tree shown in FIG. 5) in the root compartment in which the resource resides;
(8) Customer deny managed policies (represented by the letter G and G* in the access tree shown in FIG. 5) that include deny policies that apply to a managed compartment in the customer's tenancy.

From the set of leaf nodes identified in the access tree 500, the access tree generator 132 then selects a subset of leaf nodes to be connected based on a set of access rules and determines an appropriate connector for connecting the subset of leaf nodes. The access tree generator connects the selected subset of leaf nodes using the determined connector to form a subtree. In certain implementations, the access tree generator 132 might determine that a subset of leaf nodes can be connected using a deny node using the access rules. For example, in the implementation of the multi-level access tree shown in FIG. 5, the access tree generator 132 may select a first leaf node 502 that represents customer deny managed policies (G-admit) that apply to a managed compartment in the customer's tenancy and a second leaf node that also represents customer deny managed policies (G*-admit) in a child compartment within the managed compartment and connect these two leaf nodes using a deny node. The result of a subtree formed using the deny node may then be combined with another subtree to form a larger subtree. In a similar manner, additional deny nodes (e.g., 508, 510, 512 and 514) may be added to the subtrees created during the tree creation process to create the final multi-level access tree.

The system described herein can thus use deny nodes within an access tree structure to enforce explicit deny policies with precision and flexibility. Deny nodes are added during tree construction dynamically at runtime, and their precedence is governed by access rules that ensure deny policies override allow policies, except when superseded by higher-level system policies. This approach enables robust, dynamic, and hierarchical access control in complex, multi-tenancy cloud environments.

The new and improved architecture of the multi-level access tree for evaluating policies provides secure framework for managing access to cloud resources within a CSPI across multiple tenancies and compartments in the CSPI. The multi-level access tree can be tailored to the specific access request being processed and can be dynamically constructed by the policy enforcement system at runtime. The evaluation of policies using the multi-level access tree can be further optimized by the policy enforcement system to enhance efficiency and reduce unnecessary computation of individual policies. These optimizations can be applied by the policy enforcement system at run time during evaluation of the multi-level access tree. For instance, while evaluating a union node (i.e., a type of connector node) in the access tree, the policy enforcement system can immediately grant the requested permission as soon as any child node in the tree provides that permission. The remaining child nodes need not be evaluated once access is granted. If the union node is composed only of empty children, it can itself be pruned from the tree, since there are no permissions to grant. For intersection nodes (i.e., another type of connector node), policy evaluation can cease as soon as any child node fails to grant the requested permission. Additionally, if an intersection node has one or more empty children (representing no possible permissions), that branch can be pruned, as it cannot contribute to granting access.

In certain implementations, the policy enforcement system described herein also includes capabilities to prune parts of the multi-level access tree that are irrelevant to the current request as the tree is being constructed. For instance, branches related to certain compartments in the tree can be excluded if the request does not target the compartment. Additionally, the use of deny nodes in the access tree can additionally allow the policy enforcement system to eliminate entire sections of the tree, further streamlining access checks. By applying optimizations during policy evaluation and strategically pruning the access tree at runtime, the policy enforcement system described herein achieves both robust access control and high operational efficiency. This ensures that only relevant policies are processed for each request, reducing workload and improving response times for complex access management scenarios in cloud environments.

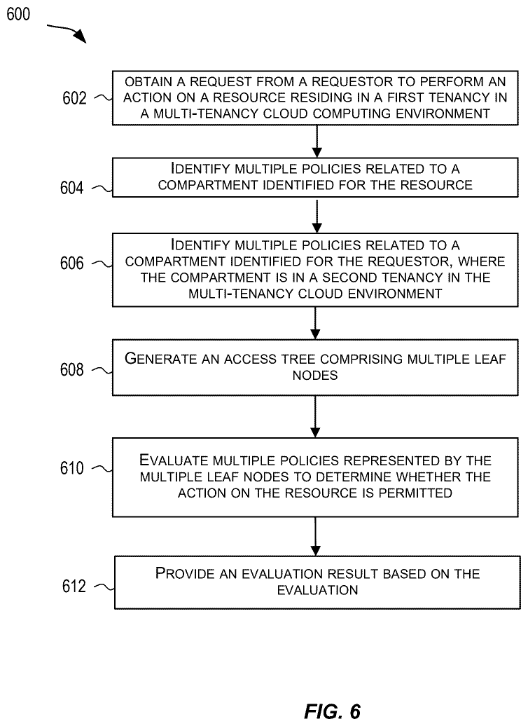

FIG. 6 depicts an example of a process 600 performed by the policy enforcement system in the CSPI shown in FIG. 1, according to certain embodiments. The processing depicted in FIG. 6 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 600 presented in FIG. 6 and described below is intended to be illustrative and non-limiting. Although FIG. 6 depicts the various processing steps occurring in a particular sequence or order, this is not intended to be limiting. In certain alternative embodiments, the steps may be performed in some different order or some steps may also be performed in parallel. In certain embodiments, the processing described in FIG. 6 may be performed by the IAM system 110 and the various subsystems (e.g., 132 and 134) of the policy enforcement system 130.

The processing depicted in FIG. 6 is initiated at block 602 when the policy enforcement system 130 obtains a request 108 from a requestor to perform an action on a resource residing in a multi-tenancy cloud computing environment (e.g., the CSPI 102). As previously described, the requestor (i.e., the entity seeking access) could be an individual user (such as a customer of the CSPI who subscribes to the services provided by the CSPI) who can make the request through several interfaces such as a console UI, an API or a via CLI in the user's device. In certain cases, the requestor can also be an application or a service, rather than a human user, who can submit the request 108 to the policy enforcement system 130 on behalf of the user. For example, the request 108 can be submitted by a “service principal”—a unique identity assigned to an application or service (e.g., 106) within the cloud environment to perform a specific action (such as reading, writing, or deleting data) on a resource within the cloud environment. For instance, a database service 106 (as a service principal) in tenancy A 112 may need to access an object storage bucket managed by a customer in a specific compartment in tenancy B 118.

At block 604, the policy enforcement system identifies multiple policies related to a compartment identified for the resource. For instance, these policies may include:
(1) Root Compartment Policies (e.g., 128) which comprise policies attached to the root compartment (e.g., 120), which generally apply to all compartments and resources within the tenancy (e.g., tenancy B 118). These policies may serve as the overarching rules that govern access across the entire tenancy;
(2) Managed Compartment Policies (e.g., 126) which comprise policies are specific to the compartment (e.g., 122) where the resource (e.g., 124) is located, which may define more granular or restrictive rules for accessing resources within that compartment; and
(3) Child Compartment Policies (if any)-If the resource's compartment contains any child compartments (sub-compartments), the policy enforcement system 130 may also collect policies associated with these compartments.

At block 606, the policy enforcement system identifies multiple policies related to a compartment identified for the requestor of the resource. For instance, these policies may include:
(1) Root Compartment Policies (e.g., 116) which are policies attached to the root compartment (e.g., 114), which typically apply across the entire tenancy (e.g., tenancy A 112) and to any entities within it.
(2) Intermediate and Immediate Compartment Policies which are policies specific to each parent compartment and the compartment where the requestor is located.

At block 608, the policy enforcement system generates an access tree comprising multiple sets of policies. An example of the processing performed by the policy enforcement system to generate an access tree is described in FIG. 3 above.

At block 610, the policy enforcement system evaluates the multiple policies represented by multiple leaf noes in the access tree to determine whether the action on the resource is permitted.

At block 612, the policy enforcement system provides an evaluation result based on the evaluation. The result (e.g., 144) is presented to the user, typically through the user interface (UI) on their device, providing clear feedback on whether the requested operation was allowed or blocked. By evaluating policies across multiple tenancies and compartments, and organizing resources according to logical criteria, the policy enforcement system described herein provides a comprehensive and secure framework for managing access to cloud resources within a CSPI.

### Example Cloud Architectures

The term cloud service is generally used to refer to a service that is made available by a cloud services provider (CSP) to users or customers on demand (e.g., via a subscription model) using systems and infrastructure (cloud infrastructure) provided by the CSP. Typically, the servers and systems that make up the CSP's infrastructure are separate from the customer's own on premise servers and systems. Customers can thus avail themselves of cloud services provided by the CSP without having to purchase separate hardware and software resources for the services. Cloud services are designed to provide a subscribing customer easy, scalable access to applications and computing resources without the customer having to invest in procuring the infrastructure that is used for providing the services.

There are several cloud service providers that offer various types of cloud services. There are various different types or models of cloud services including Software-as-a-Service (SaaS), Platform-as-a-Service (PaaS), Infrastructure-as-a-Service (IaaS), and others.

A customer can subscribe to one or more cloud services provided by a CSP. The customer can be any entity such as an individual, an organization, an enterprise, and the like. When a customer subscribes to or registers for a service provided by a CSP, a tenancy or an account is created for that customer. The customer can then, via this account, access the subscribed-to one or more cloud resources associated with the account

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

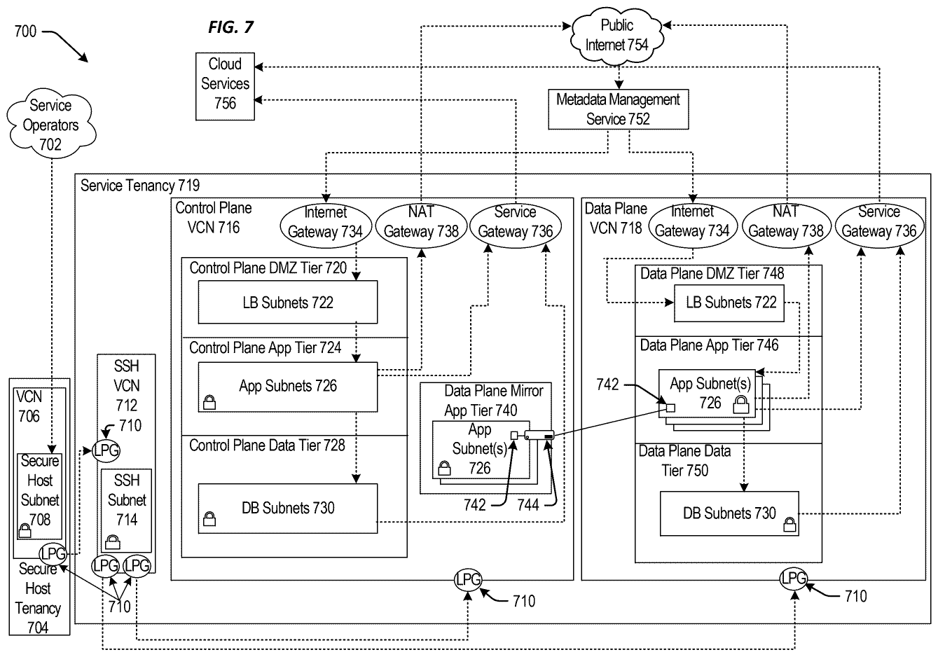

FIG. 7 is a block diagram 700 illustrating an example pattern of an IaaS architecture, according to at least one embodiment. Service operators 702 can be communicatively coupled to a secure host tenancy 704 that can include a virtual cloud network (VCN) 706 and a secure host subnet 708. In some examples, the service operators 702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 706 and/or the Internet.

The VCN 706 can include a local peering gateway (LPG) 710 that can be communicatively coupled to a secure shell (SSH) VCN 712 via an LPG 710 contained in the SSH VCN 712. The SSH VCN 712 can include an SSH subnet 714, and the SSH VCN 712 can be communicatively coupled to a control plane VCN 716 via the LPG 710 contained in the control plane VCN 716. Also, the SSH VCN 712 can be communicatively coupled to a data plane VCN 718 via an LPG 710. The control plane VCN 716 and the data plane VCN 718 can be contained in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 contained in the control plane DMZ tier 720 can be communicatively coupled to the app subnet(s) 726 contained in the control plane app tier 724 and an Internet gateway 734 that can be contained in the control plane VCN 716, and the app subnet(s) 726 can be communicatively coupled to the DB subnet(s) 730 contained in the control plane data tier 728 and a service gateway 736 and a network address translation (NAT) gateway 738. The control plane VCN 716 can include the service gateway 736 and the NAT gateway 738.

The control plane VCN 716 can include a data plane mirror app tier 740 that can include app subnet(s) 726. The app subnet(s) 726 contained in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be contained in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 718. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively couple to cloud services 756.

In some examples, the service gateway 736 of the control plane VCN 716 or of the data plane VCN 718 can make application programming interface (API) calls to cloud services 756 without going through public Internet 754. The API calls to cloud services 756 from the service gateway 736 can be one-way: the service gateway 736 can make API calls to cloud services 756, and cloud services 756 can send requested data to the service gateway 736. But, cloud services 756 may not initiate API calls to the service gateway 736.

In some examples, the secure host tenancy 704 can be directly connected to the service tenancy 719, which may be otherwise isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision desired resources. Desired resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be contained in the data plane mirror app tier 740 and the data plane app tier 746.

In some examples, users of the system, or customers, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 contained in the control plane DMZ tier 720. The LB subnet(s) 722 may determine that the request is valid, and in response to this determination, the LB subnet(s) 722 can transmit the request to app subnet(s) 726 contained in the control plane app tier 724. If the request is validated and requires a call to public Internet 754, the call to public Internet 754 may be transmitted to the NAT gateway 738 that can make the call to public Internet 754. Metadata that may be desired to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to configuration may be desired to be applied to the resources contained in the data plane VCN 718. Via a VNIC 742, the control plane VCN 716 can directly communicate with, and can thereby execute the changes, updates, or other suitable modifications to configuration to, resources contained in the data plane VCN 718.

In some embodiments, the control plane VCN 716 and the data plane VCN 718 can be contained in the service tenancy 719. In this case, the user, or the customer, of the system may not own or operate either the control plane VCN 716 or the data plane VCN 718. Instead, the IaaS provider may own or operate the control plane VCN 716 and the data plane VCN 718, both of which may be contained in the service tenancy 719. This embodiment can enable isolation of networks that may prevent users or customers from interacting with other users', or other customers', resources. Also, this embodiment may allow users or customers of the system to store databases privately without needing to rely on public Internet 754, which may not have a desired level of threat prevention, for storage.

In other embodiments, the LB subnet(s) 722 contained in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may desire this embodiment since database(s) that the customers use may be controlled by the IaaS provider and may be stored on the service tenancy 719, which may be isolated from public Internet 754.

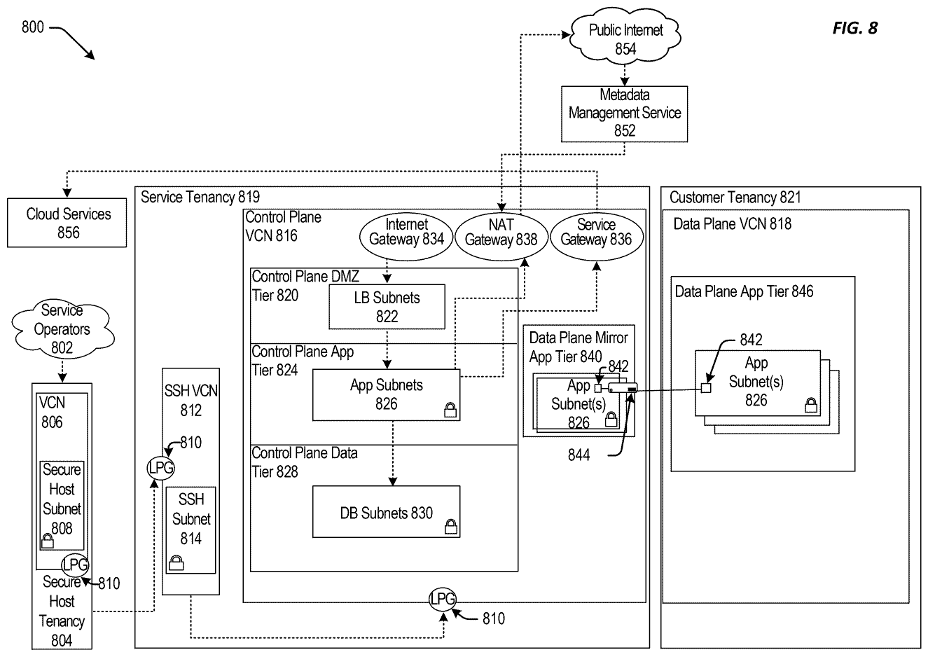

FIG. 8 is a block diagram 800 illustrating another example pattern of an IaaS architecture, according to at least one embodiment. Service operators 802 (e.g., service operators 702 of FIG. 7) can be communicatively coupled to a secure host tenancy 804 (e.g., the secure host tenancy 704 of FIG. 7) that can include a virtual cloud network (VCN) 806 (e.g., the VCN 706 of FIG. 7) and a secure host subnet 808 (e.g., the secure host subnet 708 of FIG. 7). The VCN 806 can include a local peering gateway (LPG) 810 (e.g., the LPG 710 of FIG. 7) that can be communicatively coupled to a secure shell (SSH) VCN 812 (e.g., the SSH VCN 712 of FIG. 7) via an LPG 710 contained in the SSH VCN 812. The SSH VCN 812 can include an SSH subnet 814 (e.g., the SSH subnet 714 of FIG. 7), and the SSH VCN 812 can be communicatively coupled to a control plane VCN 816 (e.g., the control plane VCN 716 of FIG. 7) via an LPG 810 contained in the control plane VCN 816. The control plane VCN 816 can be contained in a service tenancy 819 (e.g., the service tenancy 719 of FIG. 7), and the data plane VCN 818 (e.g., the data plane VCN 718 of FIG. 7) can be contained in a customer tenancy 821 that may be owned or operated by users, or customers, of the system.

The control plane VCN 816 can include a control plane DMZ tier 820 (e.g., the control plane DMZ tier 720 of FIG. 7) that can include LB subnet(s) 822 (e.g., LB subnet(s) 722 of FIG. 7), a control plane app tier 824 (e.g., the control plane app tier 724 of FIG. 7) that can include app subnet(s) 826 (e.g., app subnet(s) 726 of FIG. 7), a control plane data tier 828 (e.g., the control plane data tier 728 of FIG. 7) that can include database (DB) subnet(s) 830 (e.g., similar to DB subnet(s) 730 of FIG. 7). The LB subnet(s) 822 contained in the control plane DMZ tier 820 can be communicatively coupled to the app subnet(s) 826 contained in the control plane app tier 824 and an Internet gateway 834 (e.g., the Internet gateway 734 of FIG. 7) that can be contained in the control plane VCN 816, and the app subnet(s) 826 can be communicatively coupled to the DB subnet(s) 830 contained in the control plane data tier 828 and a service gateway 836 (e.g., the service gateway 736 of FIG. 7) and a network address translation (NAT) gateway 838 (e.g., the NAT gateway 738 of FIG. 7). The control plane VCN 816 can include the service gateway 836 and the NAT gateway 838.

The control plane VCN 816 can include a data plane mirror app tier 840 (e.g., the data plane mirror app tier 740 of FIG. 7) that can include app subnet(s) 826. The app subnet(s) 826 contained in the data plane mirror app tier 840 can include a virtual network interface controller (VNIC) 842 (e.g., the VNIC of 742) that can execute a compute instance 844 (e.g., similar to the compute instance 744 of FIG. 7). The compute instance 844 can facilitate communication between the app subnet(s) 826 of the data plane mirror app tier 840 and the app subnet(s) 826 that can be contained in a data plane app tier 846 (e.g., the data plane app tier 746 of FIG. 7) via the VNIC 842 contained in the data plane mirror app tier 840 and the VNIC 842 contained in the data plane app tier 846.

The Internet gateway 834 contained in the control plane VCN 816 can be communicatively coupled to a metadata management service 852 (e.g., the metadata management service 752 of FIG. 7) that can be communicatively coupled to public Internet 854 (e.g., public Internet 754 of FIG. 7). Public Internet 854 can be communicatively coupled to the NAT gateway 838 contained in the control plane VCN 816. The service gateway 836 contained in the control plane VCN 816 can be communicatively couple to cloud services 856 (e.g., cloud services 756 of FIG. 7).

In some examples, the data plane VCN 818 can be contained in the customer tenancy 821. In this case, the IaaS provider may provide the control plane VCN 816 for each customer, and the IaaS provider may, for each customer, set up a unique compute instance 844 that is contained in the service tenancy 819. Each compute instance 844 may allow communication between the control plane VCN 816, contained in the service tenancy 819, and the data plane VCN 818 that is contained in the customer tenancy 821. The compute instance 844 may allow resources, that are provisioned in the control plane VCN 816 that is contained in the service tenancy 819, to be deployed or otherwise used in the data plane VCN 818 that is contained in the customer tenancy 821.

In other examples, the customer of the IaaS provider may have databases that live in the customer tenancy 821. In this example, the control plane VCN 816 can include the data plane mirror app tier 840 that can include app subnet(s) 826. The data plane mirror app tier 840 can reside in the data plane VCN 818, but the data plane mirror app tier 840 may not live in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818 but may not be configured to make calls to any entity contained in the control plane VCN 816. The customer may desire to deploy or otherwise use resources in the data plane VCN 818 that are provisioned in the control plane VCN 816, and the data plane mirror app tier 840 can facilitate the desired deployment, or other usage of resources, of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, contained in the customer tenancy 821, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be live or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 7,” may be located in Region 1 and in “Region 2.” If a call to Deployment 7 is made by the service gateway 836 contained in the control plane VCN 816 located in Region 1, the call may be transmitted to Deployment 7 in Region 1. In this example, the control plane VCN 816, or Deployment 7 in Region 1, may not be communicatively coupled to, or otherwise in communication with, Deployment 7 in Region 2.

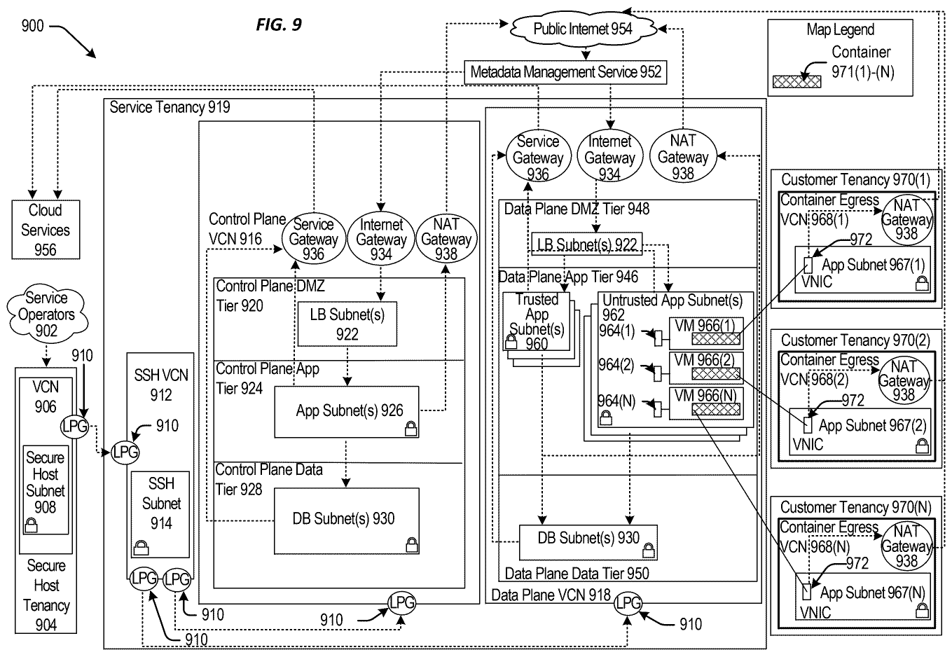

FIG. 9 is a block diagram 900 illustrating another example pattern of an IaaS architecture, according to at least one embodiment. Service operators 902 (e.g., service operators 702 of FIG. 7) can be communicatively coupled to a secure host tenancy 904 (e.g., the secure host tenancy 704 of FIG. 7) that can include a virtual cloud network (VCN) 906 (e.g., the VCN 706 of FIG. 7) and a secure host subnet 908 (e.g., the secure host subnet 708 of FIG. 7). The VCN 906 can include an LPG 910 (e.g., the LPG 710 of FIG. 7) that can be communicatively coupled to an SSH VCN 912 (e.g., the SSH VCN 712 of FIG. 7) via an LPG 910 contained in the SSH VCN 912. The SSH VCN 912 can include an SSH subnet 914 (e.g., the SSH subnet 714 of FIG. 7), and the SSH VCN 912 can be communicatively coupled to a control plane VCN 916 (e.g., the control plane VCN 716 of FIG. 7) via an LPG 910 contained in the control plane VCN 916 and to a data plane VCN 918 (e.g., the data plane 718 of FIG. 7) via an LPG 910 contained in the data plane VCN 918. The control plane VCN 916 and the data plane VCN 918 can be contained in a service tenancy 919 (e.g., the service tenancy 719 of FIG. 7).

The control plane VCN 916 can include a control plane DMZ tier 920 (e.g., the control plane DMZ tier 720 of FIG. 7) that can include load balancer (LB) subnet(s) 922 (e.g., LB subnet(s) 722 of FIG. 7), a control plane app tier 924 (e.g., the control plane app tier 724 of FIG. 7) that can include app subnet(s) 926 (e.g., similar to app subnet(s) 726 of FIG. 7), a control plane data tier 928 (e.g., the control plane data tier 728 of FIG. 7) that can include DB subnet(s) 930. The LB subnet(s) 922 contained in the control plane DMZ tier 920 can be communicatively coupled to the app subnet(s) 926 contained in the control plane app tier 924 and to an Internet gateway 934 (e.g., the Internet gateway 734 of FIG. 7) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 7) and a network address translation (NAT) gateway 938 (e.g., the NAT gateway 738 of FIG. 7). The control plane VCN 916 can include the service gateway 936 and the NAT gateway 938.

The data plane VCN 918 can include a data plane app tier 946 (e.g., the data plane app tier 746 of FIG. 7), a data plane DMZ tier 948 (e.g., the data plane DMZ tier 748 of FIG. 7), and a data plane data tier 950 (e.g., the data plane data tier 750 of FIG. 7). The data plane DMZ tier 948 can include LB subnet(s) 922 that can be communicatively coupled to trusted app subnet(s) 960 and untrusted app subnet(s) 962 of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include one or more primary VNICs 964(1)-(N) that can be communicatively coupled to tenant virtual machines (VMs) 966(1)-(N). Each tenant VM 966(1)-(N) can be communicatively coupled to a respective app subnet 967(1)-(N) that can be contained in respective container egress VCNs 968(1)-(N) that can be contained in respective customer tenancies 970(1)-(N). Respective secondary VNICs 972(1)-(N) can facilitate communication between the untrusted app subnet(s) 962 contained in the data plane VCN 918 and the app subnet contained in the container egress VCNs 968(1)-(N). Each container egress VCNs 968(1)-(N) can include a NAT gateway 938 that can be communicatively coupled to public Internet 954 (e.g., public Internet 754 of FIG. 7).

The Internet gateway 934 contained in the control plane VCN 916 and contained in the data plane VCN 918 can be communicatively coupled to a metadata management service 952 (e.g., the metadata management system 752 of FIG. 7) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively couple to cloud services 956.

In some embodiments, the data plane VCN 918 can be integrated with customer tenancies 970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 946. Code to run the function may be executed in the VMs 966(1)-(N), and the code may not be configured to run anywhere else on the data plane VCN 918. Each VM 966(1)-(N) may be connected to one customer tenancy 970. Respective containers 971(1)-(N) contained in the VMs 966(1)-(N) may be configured to run the code. In this case, there can be a dual isolation (e.g., the containers 971(1)-(N) running code, where the containers 971(1)-(N) may be contained in at least the VM 966(1)-(N) that are contained in the untrusted app subnet(s) 962), which may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completion of running the code, the IaaS provider may kill or otherwise dispose of the containers 971(1)-(N).

In some embodiments, the trusted app subnet(s) 960 may run code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be contained in the VM 966(1)-(N) of each customer and that may run code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

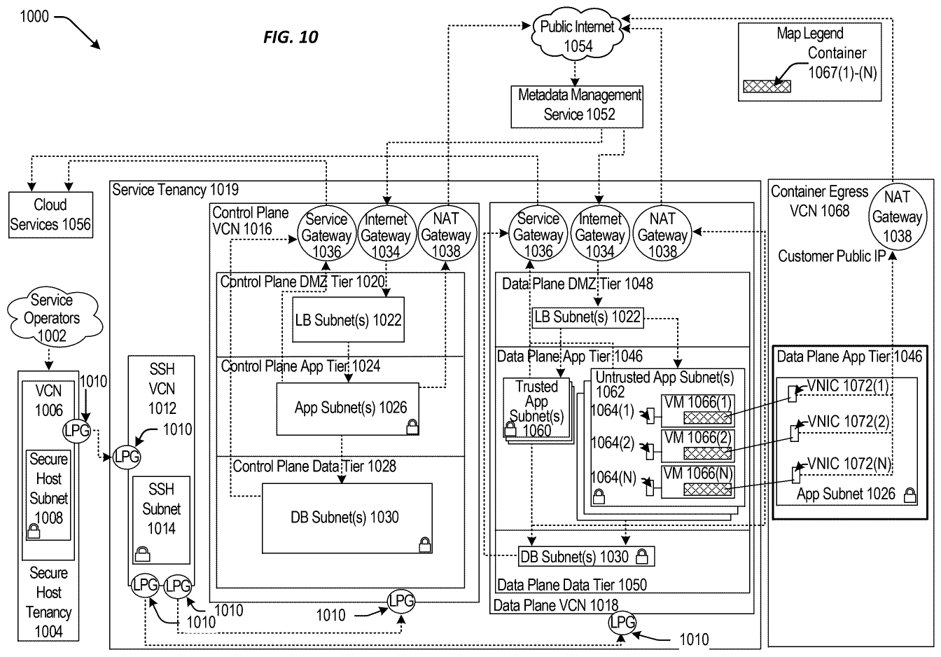

FIG. 10 is a block diagram 1000 illustrating another example pattern of an IaaS architecture, according to at least one embodiment. Service operators 1002 (e.g., service operators 702 of FIG. 7) can be communicatively coupled to a secure host tenancy 1004 (e.g., the secure host tenancy 704 of FIG. 7) that can include a virtual cloud network (VCN) 1006 (e.g., the VCN 706 of FIG. 7) and a secure host subnet 1008 (e.g., the secure host subnet 708 of FIG. 7). The VCN 1006 can include an LPG 1010 (e.g., the LPG 710 of FIG. 7) that can be communicatively coupled to an SSH VCN 1012 (e.g., the SSH VCN 712 of FIG. 7) via an LPG 1010 contained in the SSH VCN 1012. The SSH VCN 1012 can include an SSH subnet 1014 (e.g., the SSH subnet 714 of FIG. 7), and the SSH VCN 1012 can be communicatively coupled to a control plane VCN 1016 (e.g., the control plane VCN 716 of FIG. 7) via an LPG 1010 contained in the control plane VCN 1016 and to a data plane VCN 1018 (e.g., the data plane 718 of FIG. 7) via an LPG 1010 contained in the data plane VCN 1018. The control plane VCN 1016 and the data plane VCN 1018 can be contained in a service tenancy 1019 (e.g., the service tenancy 719 of FIG. 7).

The control plane VCN 1016 can include a control plane DMZ tier 1020 (e.g., the control plane DMZ tier 720 of FIG. 7) that can include LB subnet(s) 1022 (e.g., LB subnet(s) 722 of FIG. 7), a control plane app tier 1024 (e.g., the control plane app tier 724 of FIG. 7) that can include app subnet(s) 1026 (e.g., app subnet(s) 726 of FIG. 7), a control plane data tier 1028 (e.g., the control plane data tier 728 of FIG. 7) that can include DB subnet(s) 1030 (e.g., DB subnet(s) 930 of FIG. 9). The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 734 of FIG. 7) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 7) and a network address translation (NAT) gateway 1038 (e.g., the NAT gateway 738 of FIG. 7). The control plane VCN 1016 can include the service gateway 1036 and the NAT gateway 1038.

The data plane VCN 1018 can include a data plane app tier 1046 (e.g., the data plane app tier 746 of FIG. 7), a data plane DMZ tier 1048 (e.g., the data plane DMZ tier 748 of FIG. 7), and a data plane data tier 1050 (e.g., the data plane data tier 750 of FIG. 7). The data plane DMZ tier 1048 can include LB subnet(s) 1022 that can be communicatively coupled to trusted app subnet(s) 1060 (e.g., trusted app subnet(s) 960 of FIG. 9) and untrusted app subnet(s) 1062 (e.g., untrusted app subnet(s) 962 of FIG. 9) of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include primary VNICs 1064(1)-(N) that can be communicatively coupled to tenant virtual machines (VMs) 1066(1)-(N) residing within the untrusted app subnet(s) 1062. Each tenant VM 1066(1)-(N) can run code in a respective container 1067(1)-(N), and be communicatively coupled to an app subnet 1026 that can be contained in a data plane app tier 1046 that can be contained in a container egress VCN 1068. Respective secondary VNICs 1072(1)-(N) can facilitate communication between the untrusted app subnet(s) 1062 contained in the data plane VCN 1018 and the app subnet contained in the container egress VCN 1068. The container egress VCN can include a NAT gateway 1038 that can be communicatively coupled to public Internet 1054 (e.g., public Internet 754 of FIG. 7).

The Internet gateway 1034 contained in the control plane VCN 1016 and contained in the data plane VCN 1018 can be communicatively coupled to a metadata management service 1052 (e.g., the metadata management system 752 of FIG. 7) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively couple to cloud services 1056.

In some examples, the pattern illustrated by the architecture of block diagram 1000 of FIG. 10 may be considered an exception to the pattern illustrated by the architecture of block diagram 900 of FIG. 9 and may be desirable for a customer of the IaaS provider if the IaaS provider cannot directly communicate with the customer (e.g., a disconnected region). The respective containers 1067(1)-(N) that are contained in the VMs 1066(1)-(N) for each customer can be accessed in real-time by the customer. The containers 1067(1)-(N) may be configured to make calls to respective secondary VNICs 1072(1)-(N) contained in app subnet(s) 1026 of the data plane app tier 1046 that can be contained in the container egress VCN 1068. The secondary VNICs 1072(1)-(N) can transmit the calls to the NAT gateway 1038 that may transmit the calls to public Internet 1054. In this example, the containers 1067(1)-(N) that can be accessed in real-time by the customer can be isolated from the control plane VCN 1016 and can be isolated from other entities contained in the data plane VCN 1018. The containers 1067(1)-(N) may also be isolated from resources from other customers.

In other examples, the customer can use the containers 1067(1)-(N) to call cloud services 1056. In this example, the customer may run code in the containers 1067(1)-(N) that requests a service from cloud services 1056. The containers 1067(1)-(N) can transmit this request to the secondary VNICs 1072(1)-(N) that can transmit the request to the NAT gateway that can transmit the request to public Internet 1054. Public Internet 1054 can transmit the request to LB subnet(s) 1022 contained in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, 1000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

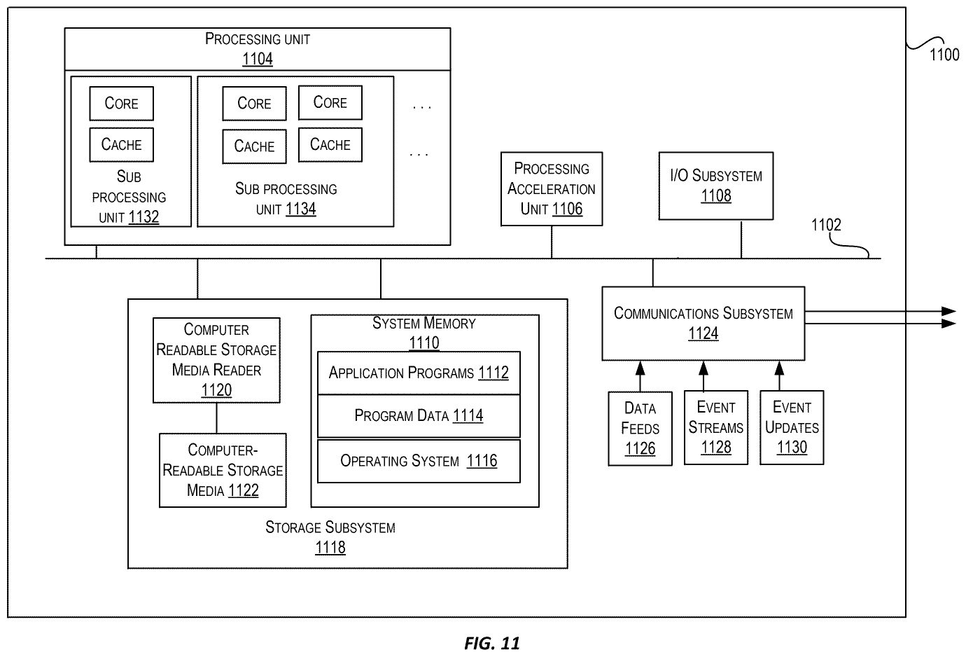

FIG. 11 illustrates an example computer system 1100, in which various embodiments may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that comprises software elements, shown as being currently located within a system memory 1110. System memory 1110 may store program instructions that are loadable and executable on processing unit 1104, as well as data generated during the execution of these programs.

Depending on the configuration and type of computer system 1100, system memory 1110 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1104. In some implementations, system memory 1110 may include multiple different types of memory, such as static random access memory (SRAM) or dynamic random access memory (DRAM). In some implementations, a basic input/output system (BIOS), containing the basic routines that help to transfer information between elements within computer system 1100, such as during start-up, may typically be stored in the ROM. By way of example, and not limitation, system memory 1110 also illustrates application programs 1112, which may include client applications, Web browsers, mid-tier applications, relational database management systems (RDBMS), etc., program data 1114, and an operating system 1116. By way of example, operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems.

Storage subsystem 1118 may also provide a tangible computer-readable storage medium for storing the basic programming and data constructs that provide the functionality of some embodiments. Software (programs, code modules, instructions) that when executed by a processor provide the functionality described above may be stored in storage subsystem 1118. These software modules or instructions may be executed by processing unit 1104. Storage subsystem 1118 may also provide a repository for storing data used in accordance with the present disclosure.

Storage subsystem 1100 may also include a computer-readable storage media reader 1120 that can further be connected to computer-readable storage media 1122. Together and, optionally, in combination with system memory 1110, computer-readable storage media 1122 may comprehensively represent remote, local, fixed, and/or removable storage devices plus storage media for temporarily and/or more permanently containing, storing, transmitting, and retrieving computer-readable information.

Computer-readable storage media 1122 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1100.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
obtaining, by a computer system, a request to perform an action on a resource, wherein the resource resides in a first tenancy in a multi-tenancy cloud computing environment;
identifying, by the computer system, a first plurality of policies related to a compartment identified for the resource;
identifying, by the computer system, a second plurality of policies related to a compartment identified for a requestor of the request, wherein the compartment is in a second tenancy in the multi-tenancy cloud environment;
generating, by the computer system, an access tree comprising a plurality of leaf nodes, wherein a first leaf node in the plurality of leaf nodes represents the first plurality of policies and a second leaf node in the plurality of leaf nodes represents the second plurality of policies;
evaluating, by the computer system, the access tree comprising at least the first plurality of policies represented by the first leaf node and the second plurality of policies represented by the second leaf node to determine whether the action on the resource is permitted; and
providing, by the computer system, an evaluation result based on the evaluation.

2. The computer-implemented method of claim 1 further comprising:
identifying a third plurality of policies, wherein the third plurality of policies are associated with a child compartment related to the resource;
representing the third plurality of polices by a third leaf node in the access tree; and wherein:
determining whether the action on the resource is permitted is further based on evaluating the access tree comprising the third plurality of policies.

3. The computer-implemented method of claim 1 further comprising:
identifying a fourth plurality of policies, wherein the fourth plurality of policies is associated with an ancestor compartment related to the resource;
representing the fourth plurality of policies by a fourth leaf node in the access tree; and wherein:
determining whether the action on the resource is permitted is further based on evaluating the access tree comprising the fourth plurality of policies.

4. The computer-implemented method of claim 1 further comprising:
identifying a fifth plurality of policies, wherein the fifth plurality of policies is related to an ancestor compartment related to the requestor;
representing the fifth plurality of polices by a fifth leaf node in the access tree; and wherein:
determining whether the action on the resource is permitted is further based on evaluating the access tree comprising the fifth plurality of policies.

5. The computer-implemented method of claim 1 further comprising:
identifying a plurality of system policies, wherein the plurality of system policies represent policies that apply to any tenancy in a plurality of tenancies in the multi-tenancy cloud computing environment, wherein the plurality of tenancies comprise at least the first tenancy and the second tenancy; and
identifying a plurality of managed system policies, wherein the plurality of managed system policies represent policies that apply to any managed compartment in a plurality of tenancies in the multi-tenancy cloud computing environment.

6. The computer-implemented method of claim 5, wherein determining whether the action on the resource is permitted is further based on evaluating the access tree comprising the plurality of system policies and the plurality of managed system policies, wherein the plurality of system policies is represented by a sixth leaf node in the access tree and the plurality of managed system policies is represented by a seventh leaf node in the access tree.

7. The computer-implemented method of claim 1, wherein generating the access tree comprising the plurality of leaf nodes comprises:
selecting, from the plurality of leaf nodes, a subset of leaf nodes to be connected based on a plurality of access rules;
determining a connector node for connecting the selected subset of leaf nodes; and
connecting the selected subset of leaf nodes using the determined connector to generate a subtree.

8. The computer-implemented method of claim 1, wherein generating the access tree comprising a plurality of leaf nodes comprises:
generating a plurality of subtrees, wherein a subtree in the plurality of subtrees is generated by selecting, from the plurality of leaf nodes, a subset of leaf nodes to be connected using a plurality of access rules;
selecting, from the plurality of subtrees, a subset of subtrees to be connected using the plurality of access rules;
determining a connector node for connecting the subset of subtrees; and
connecting the selected subset of subtrees using the determined connector to generate the access tree.

9. The computer-implemented method of claim 8, wherein the connector node for connecting the subset of subtrees is an intersection node or a union node.

10. The computer-implemented method of claim 8, wherein the plurality of access rules comprise information that identifies at least one of a relationship between at least the first tenancy and the second tenancy identified in the access request, a relationship between the first set of policies and the second set of policies or a relationship between the first set of policies, the second set of policies and a plurality of system policies, wherein the plurality of system policies represent policies that are applicable to any tenancy in the plurality of tenancies in the multi-tenancy cloud computing environment.

11. The computer-implemented method of claim 1, wherein generating the access tree comprising the plurality of leaf nodes comprises:
selecting, from the plurality of leaf nodes, a subset of leaf nodes to be connected based on a plurality of access rules;
determining a deny node for connecting the selected subset of leaf nodes, wherein the deny node represents a deny policy that is applicable to the request; and
connecting the selected subset of leaf nodes using the deny node using the plurality of access rules.

12. The computer-implemented method of claim 1, wherein determining the deny node for connecting the selected subset of leaf nodes is performed dynamically during the generation of the access tree.

13. The computer-implemented method of claim 1, wherein the access tree is dynamically generated at runtime based on the request to perform the action on the resource.

14. The computer-implemented method of claim 1, wherein the first tenancy in the multi-tenancy cloud computing environment is different from the second tenancy in the multi-tenancy cloud computing environment.

15. A system comprising:
one or more processors; and
non-transitory computer-readable storage medium storing instructions which, when executed by the one or more processors, cause the system to:
obtaining a request to perform an action on a resource, wherein the resource resides in a first tenancy in a multi-tenancy cloud computing environment;
identifying a first plurality of policies related to a compartment identified for the resource;
identifying a second plurality of policies related to a compartment identified for a requestor of the request, wherein the compartment is in a second tenancy in the multi-tenancy cloud environment;
generating an access tree comprising a plurality of leaf nodes, wherein a first leaf node in the plurality of leaf nodes represents the first plurality of policies and a second leaf node in the plurality of leaf nodes represents the second plurality of policies;
evaluating the access tree comprising at least the first plurality of policies represented by the first leaf node and the second plurality of policies represented by the second leaf node to determine whether the action on the resource is permitted; and
providing an evaluation result based on the evaluation.

16. The system of claim 15 further comprising:
identifying a plurality of system policies, wherein the plurality of system policies represent policies that apply to any tenancy in a plurality of tenancies in the multi-tenancy cloud computing environment, wherein the plurality of tenancies comprise at least the first tenancy and the second tenancy; and
identifying a plurality of managed system policies, wherein the plurality of managed system policies represent policies that apply to any managed compartment in a plurality of tenancies in the multi-tenancy cloud computing environment.

17. The system of claim 16, wherein determining whether the action on the resource is permitted is further based on evaluating the access tree comprising the plurality of system policies and the plurality of managed system policies, wherein the plurality of system policies is represented by a third leaf node in the access tree and the plurality of managed system policies is represented by a fourth leaf node in the access tree.

18. The system of claim 15, wherein generating the access tree comprising the plurality of leaf nodes comprises:
selecting, from the plurality of leaf nodes, a subset of leaf nodes to be connected based on a plurality of access rules;
determining a connector node for connecting the selected subset of leaf nodes; and
connecting the selected subset of leaf nodes using the determined connector to generate a subtree.

19. A non-transitory computer-readable medium storing instructions executable by a computer system that, when executed by one or more processors of the computer system, cause the one or more processors to perform operations comprising:
obtaining a request to perform an action on a resource, wherein the resource resides in a first tenancy in a multi-tenancy cloud computing environment;
identifying a first plurality of policies related to a compartment identified for the resource;
identifying a second plurality of policies related to a compartment identified for a requestor of the request, wherein the compartment is in a second tenancy in the multi-tenancy cloud environment;
generating an access tree comprising a plurality of leaf nodes, wherein a first leaf node in the plurality of leaf nodes represents the first plurality of policies and a second leaf node in the plurality of leaf nodes represents the second plurality of policies;
evaluating the access tree comprising at least the first plurality of policies represented by the first leaf node and the second plurality of policies represented by the second leaf node to determine whether the action on the resource is permitted; and
providing an evaluation result based on the evaluation.

20. The non-transitory computer-readable medium of claim 19, wherein the first tenancy in the multi-tenancy cloud computing environment is different from the second tenancy in the multi-tenancy cloud computing environment.
